(19) United States
(12) Patent Application Publication
(10) Pub. No.: US 2010/0206405 A1
(43) Pub. Date: Aug. 19, 2010

(54) PILOT OPERATED CHECK VALVE

(75) Inventor: Trevor MCCONNELL, Rittman, OH (US)

Correspondence Address: SIMPSON & SIMPSON, PLLC, 5555 MAIN STREET, WILLIAMSVILLE, NY, 14221-5406, US

(73) Assignee: LuK Lamellen und Kupplungsbau Beteiligungs KG, Buehl (DE)

(21) Appl. No.: 12/703,413

(22) Filed: Feb. 10, 2010

Related U.S. Application Data
(60) Provisional application No. 61/153,682, filed on Feb. 19, 2009.

(51) Int. Cl. F16K 15/00

(52) U.S. Cl. 137/538

(57) ABSTRACT

A hydraulic valve having a first fluid chamber hydraulically connected to a pressure source, a second fluid chamber hydraulically connected to a pressure operator, and a blocking member for controlling fluid flow between the first and second chambers. The blocking member substantially blocks fluid flow between the first and second chambers when a pressure of fluid in the first chamber is greater than a minimum pressure and less than a pressure of fluid in the second chamber. The blocking member is displaceable to enable fluid flow between the first and second chambers when the pressure of fluid in the first chamber is below the minimum pressure.

### CROSS-REFERENCE TO RELATED APPLICATIONS

This application claims the benefit under 35 U.S.C. §119(e) of U.S. Provisional Application No. 61/153,682 filed Feb. 19, 2009, which application is incorporated herein by reference.

### FIELD OF THE INVENTION

The invention relates generally to a pilot operated check valve, and more specifically to a pilot operated check valve with low pressure release.

### BACKGROUND OF THE INVENTION

The prior art teaches a pilot operated check valve for construction equipment that enables a boom or arm to hold a weight or move downward without impact while supporting the weight. Prior art check valves generally use a spring to urge a blocking member to substantially block fluid flow and restrain operating pressure when source pressure is lost.

FIG. 1 is a section view of prior art pilot operated check valve 10. Prior art valve 10 includes housing 12 with fluid chambers 14 and 16. Fluid chamber 14 is connected to any pressure source known in the art. Fluid chamber 14 may be connected to a hydraulic pump or hydraulic accumulator, for example. Fluid chamber 16 is connected to any pressure operator known in the art. Fluid chamber 16 may be connected to a hydraulic motor or hydraulic cylinder, for example.

Valve 10 controls hydraulic fluid flow between the pressure source (not shown) and the pressure operator (not shown) by controlling hydraulic fluid flow between fluid chambers 14 and 16. Valve 10 further includes blocking member 18 and pilot chamber 20 for controlling fluid flow between fluid chambers 14 and 16. Blocking member 18 substantially blocks fluid flow between fluid chambers 14 and 16 when a pressure of fluid in chamber 14 is less than a pressure of fluid in chamber 16, and a pressure of fluid in pilot chamber 20 is below a minimum pressure necessary to overcome force applied to blocking member 18 by spring 22. That is, blocking member 18 substantially blocks flow when there is little or no pressure in chambers 14 and 20.

### BRIEF SUMMARY OF THE INVENTION

Example aspects of the present invention broadly comprise a hydraulic valve having a first fluid chamber hydraulically connected to a pressure source, a second fluid chamber hydraulically connected to a pressure operator, and a blocking member for controlling fluid flow between the first and second chambers. The blocking member substantially blocks fluid flow between the first and second chambers when a pressure of fluid in the first chamber is greater than a minimum pressure and less than a pressure of fluid in the second chamber. The blocking member is displaceable to enable fluid flow between the first and second chambers when the pressure of fluid in the first chamber is below the minimum pressure.

In some example embodiments of the invention, the hydraulic valve includes a first piston disposed in the second chamber and a first spring disposed in the second chamber. The blocking member is connected to the first piston and is urgeable into a position substantially blocking fluid flow between the first and second chambers by the first spring. In an example embodiment of the invention, the blocking member is integral with the first piston. In an example embodiment of the invention, the first piston comprises a channel for equalizing pressure on the first piston. In an example embodiment of the invention, the first piston and the first spring are displaceable by fluid pressure in the first chamber acting on the blocking member.

In some example embodiments of the invention, the hydraulic valve includes a second piston disposed in the first chamber and a second spring disposed in the first chamber and for displacing the second piston. The blocking member is urgeable into a position enabling fluid flow between the first and second chambers by the second piston. In an example embodiment of the invention, the second spring is displaceable by fluid pressure in the first chamber acting on the second piston. In an example embodiment of the invention, the hydraulic valve includes an end cap with a drain and the second spring is disposed between the second piston and the end cap.

Other example aspects of the invention broadly comprise a hydraulic valve including a first hydraulic chamber, a second hydraulic chamber, a first piston and spring disposed in the first chamber, a second piston and spring disposed in the second chamber, and a blocking member. The first spring urges the first piston towards the second chamber and the second spring urges the second piston towards the first chamber. The blocking member is displaceable by the first and second pistons for controlling fluid communication between the chambers. In an example embodiment of the invention, the hydraulic valve includes an end cap with a drain and the second spring is disposed between the second piston and the end cap.

Other example aspects of the invention broadly comprise a hydraulic valve including a first orifice in fluid communication with a source of pressurized fluid, a second orifice in fluid communication with an operator, and a blocking member. The blocking member is displaceable to substantially block fluid communication between the first and second orifices when a pressure of fluid at the first orifice is greater than a minimum pressure and less than a pressure of fluid at the second orifice. The blocking member is displaceable to enable fluid communication between the first and second orifices when a pressure of fluid at the first orifice is below the minimum pressure. In some example embodiments of the invention, the hydraulic valve includes first and second springs. The blocking member is urgeable by the first spring into a position substantially blocking fluid communication between the first and second orifices and the blocking member is urgeable by the second spring into a position enabling fluid communication between the first and second orifices.

Other example aspects of the invention broadly comprise a pilot operator for a check valve including a piston disposed in a chamber and a spring. The piston is displaceable by the spring to open the check valve when fluid pressure in the chamber is below a minimum value. In some example embodiments of the invention, the piston is displaceable by fluid pressure in the chamber to close the check valve when fluid pressure is above the minimum value. In some example embodiments of the invention, the pilot operator includes an end cap and the spring is disposed between the piston and the end cap. In an example embodiment of the invention, the end cap includes a drain.

### BRIEF DESCRIPTION OF THE DRAWINGS

The nature and mode of operation of the present invention will now be more fully described in the following detailed description of the invention taken with the accompanying drawing figures, in which:

FIG. 1 is a section view of a prior art pilot operated check valve assembly;

FIG. 2 is a section view of a check valve according to an example aspect of the invention;

FIG. 3 is a section view of the valve shown in FIG. 2 depicted in a valve body;

FIG. 4 is a graph showing source and operator pressures over time;

FIG. 5 is a series of figures depicting section views of the valve shown in FIG. 2 in various states of operation corresponding to segments of the graph of FIG. 4.

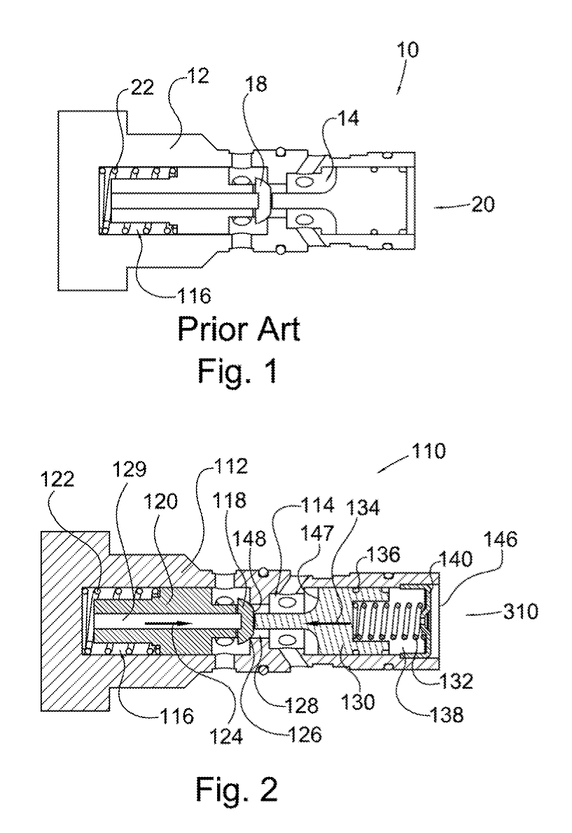

### DETAILED DESCRIPTION OF THE INVENTION

At the outset, it should be appreciated that like drawing numbers appearing in different drawing views identify identical, or functionally similar, structural elements. Furthermore, it is understood that this invention is not limited only to the particular embodiments, methodology, materials and modifications described herein, and as such may, of course, vary. It is also understood that the terminology used herein is for the purpose of describing particular aspects only, and is not intended to limit the scope of the present invention, which is limited only by the appended claims.

Unless defined otherwise, all technical and scientific terms used herein have the same meaning as commonly understood to one of ordinary skill in the art to which this invention belongs. Although any methods, devices or materials similar or equivalent to those described herein can be used in the practice or testing of the invention, the following example methods, devices, and materials are now described.

The following description is made with reference to FIG. 2. FIG. 2 is a section view of check valve 110 according to an example aspect of the invention. Valve 110 includes housing 112 with fluid chambers 114 and 116. Fluid chamber 114 is hydraulically connected to a pressure source, as shown infra. Fluid chamber 116 is hydraulically connected to a pressure operator, as shown infra. Check valve 110 further includes blocking member 118 for controlling fluid flow between chambers 114 and 116 as described below.

Piston 120 and spring 122 are disposed in chamber 116. Blocking member 118 is connected to piston 120. Spring 122 urges blocking member 118 into a position substantially blocking fluid flow between chambers 114 and 116. That is, spring 122 applies force to blocking member 118 in direction of arrow 124 bringing blocking member 118 into contact with edge 126 of channel 128. Channel 128 connects chambers 114 and 116, and contact of blocking member 118 with edge 126 substantially seals channel 128, substantially blocking fluid flow between chambers 114 and 116. In an example embodiment of the invention, blocking member 118 is integral with piston 120. In an example embodiment of the invention, piston 120 includes channel 129 for equalizing pressure on piston 120.

Piston 130 and spring 132 are disposed in chamber 114. Blocking member 118 is engageable with piston 130. For example, spring 132 urges piston 130 and blocking member 118 in direction of arrow 134 to engage and dislodge blocking member 118 from edge 126 to enable fluid flow between chambers 114 and 116. In general, the force that can be applied by spring 132 to the blocking element is greater the force that can be applied by spring 122 to the blocking element. In an example embodiment of the invention, piston 130 includes seal 136 to isolate pressure in chamber 114 from chamber 138. Spring 132 is displaceable by pressure in chamber 114 acting on piston 130. That is, seal 136 allows a pressure differential between chambers 114 and 138 to urge piston 130 in direction of arrow 124, opposite direction of arrow 134, and compress spring 132. Spring 132 is disposed between piston 130 and end cap 140. In an example embodiment of the invention, end cap 140 includes drain hole 146 for relieving pressure from leakage at seal 136.

In some example embodiments of the invention, valve 110 includes hydraulic chambers 114 and 116. Piston 130 and spring 132 are disposed in chamber 114. Spring 132 urges piston 130 towards chamber 116. Piston 120 and spring 122 are disposed in chamber 116. Spring 122 urges piston 120 towards chamber 114. Blocking member 118 is displaceable by pistons 120 and 130 for controlling fluid communication between the chambers, as described below. In an example embodiment of the invention, valve 110 includes end cap 140 with drain 146, and spring 132 is disposed between piston 130 and end cap 140.

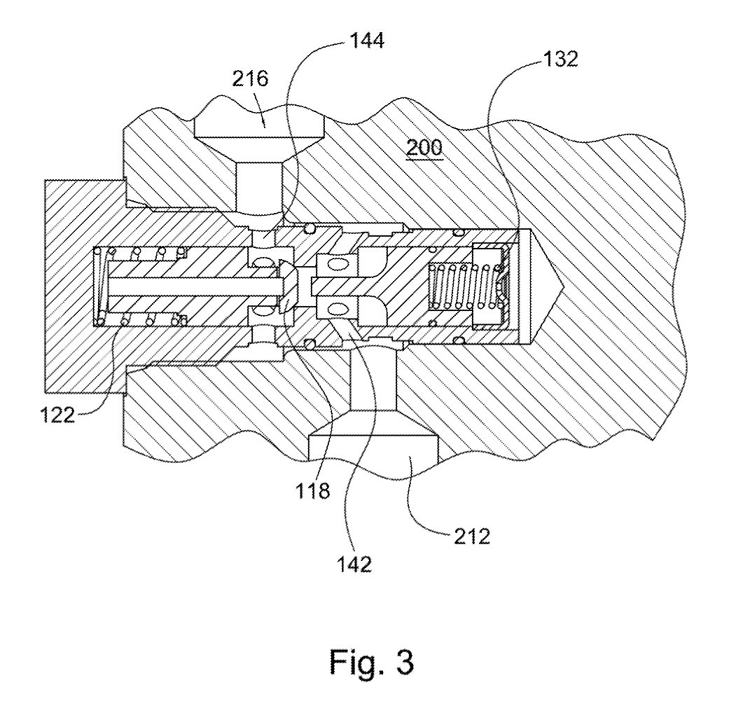

The following description is made with reference to FIG. 3. FIG. 3 is a section view of valve 110 depicted in valve body 200. Valve 110 includes orifice 142 in fluid communication with a source of pressurized fluid, through channel 212, for example. Valve 110 also includes orifice 144 in fluid communication with an operator, through channel 216, for example. Blocking member 118 is displaceable to substantially block fluid communication between orifices 142 and 144 when a pressure of fluid at orifice 142 is greater than a minimum pressure and less than a pressure of fluid at orifice 144. In general, pressure of fluid at orifice 142 exerts greater force on face 147 of piston 130 than on face 148 of blocking member 118 due to difference in pressure areas between the faces. Alternatively stated, pressure area of face 147 is larger than pressure area of face 148 so the force acting on face 147 from pressure in chamber 114 is greater than the force acting on face 148 from the same pressure.

Blocking member 118 is displaceable to enable fluid communication between orifices 142 and 144 when a pressure of fluid at orifice 210 is below the minimum pressure. As pressure in orifice 142 drops below the minimum pressure, pressure force on face 147 of piston 130 opposing force of spring 132 is lowered faster than pressure force acting on face 148 of blocking member 118 opposing force of pressure in orifice 144 until force of spring 132 overcomes the pressure force acting on blocking member 118 resulting from pressure differential in chambers 114 and 116.

In an example embodiment of the invention, valve 110 includes springs 122 and 132. Blocking member 118 is urgeable by spring 122 into a position substantially blocking fluid communication between orifices 210 and 214. Blocking member 118 is urgeable by spring 132 into a position enabling fluid communication between orifices 210 and 214.

Returning to FIG. 2, check valve 110 includes pilot operator 310. In some example embodiments of the invention, pilot operator 310 includes piston 130 disposed in chamber 114, and spring 132. Piston 130 is displaceable by spring 132 to open the check valve when fluid pressure in chamber 114 is below a minimum value. In an example embodiment of the invention, piston 130 is displaceable by fluid pressure in chamber 114 to close check valve 110 when fluid pressure is above the minimum value. In some example embodiments of the invention, pilot operator 310 includes end cap 140 and spring 132 is disposed between piston 130 and end cap 140. In an example embodiment of the invention, end cap 140 includes drain 146.

Blocking member 118 substantially blocks fluid flow between chambers 114 and 116 when a pressure of fluid in chamber 114 is greater than a minimum pressure and less than a pressure of fluid in chamber 116. Blocking member 118 is displaceable to enable fluid flow between chambers 114 and 116 when the pressure of fluid in chamber 114 is below the minimum pressure as described in further detail below.

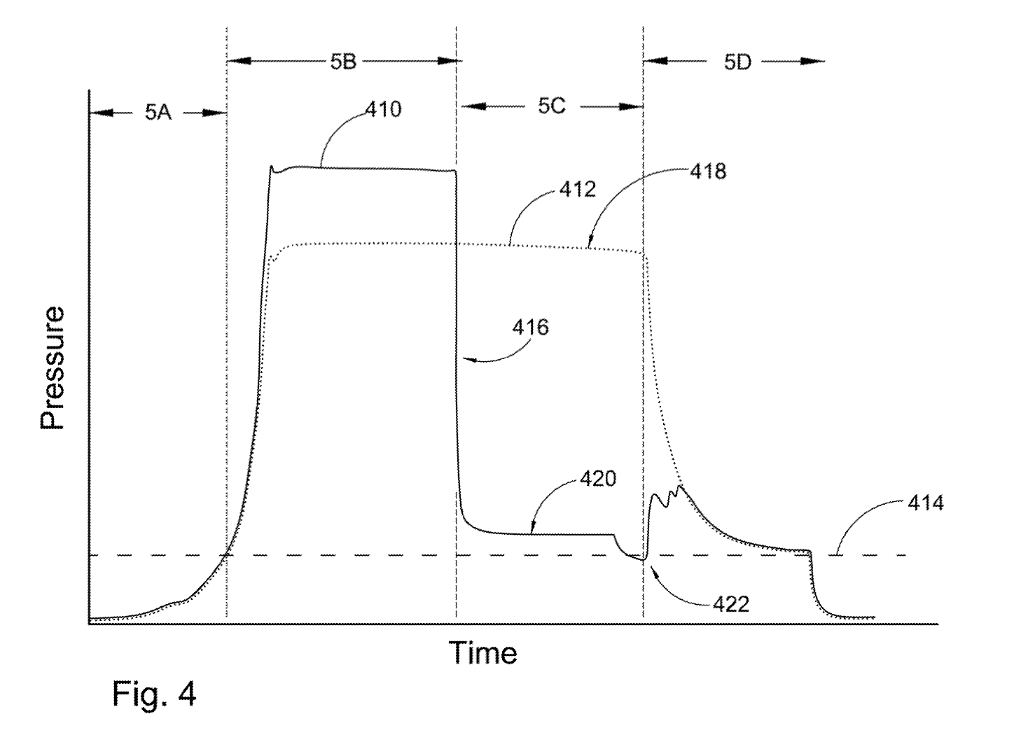

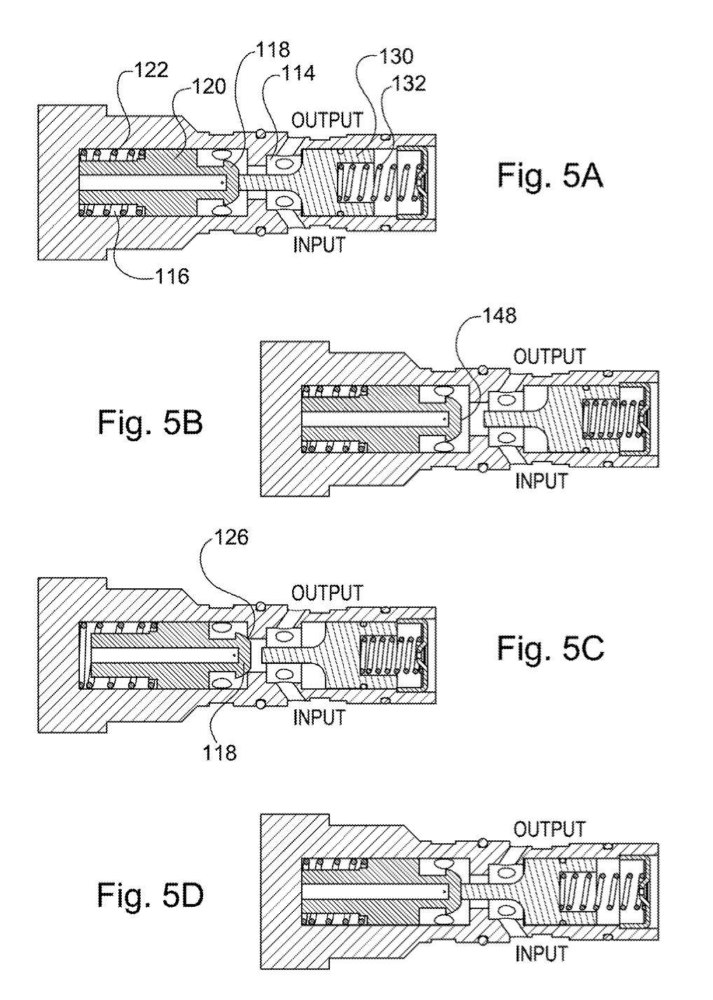

The following description is made with reference to FIGS. 2 through 5. FIG. 4 is a graph showing source and operator pressures in a present invention check valve, for example, check valve 110, over time. FIGS. 5A through 5D depict section views of valve 110 in various states of operation corresponding to segments of the graph in FIG. 4. FIG. 5A corresponds to segment 5A of FIG. 4, near the bottom left corner of the graph where source pressure curve 410, for example, present at orifice 142 and operator pressure curve 412, for example, present at orifice 144, are below minimum pressure line 414. Thus, when source and operator pressures acting on piston 130 are below minimum pressure line 414, force of spring 132 overcomes force of spring 122 to displace blocking member 118 and allow fluid communication between chambers 114 and 116.

FIG. 5B corresponds to segment 5B of FIG. 4. When source pressure 410 is above minimum pressure line 414, piston 130 is displaced by source pressure in chamber 114 and is no longer engaged with blocking member 118. However, differential pressure between chambers 114 and 116 acting on face 148 of blocking member 118 displaces piston 120 and spring 122, allowing continued fluid communication between chambers 114 and 116. That is, when fluid pressure in chamber 114 is higher than fluid pressure in chamber 116, blocking member 118 is displaced, allowing fluid communication between the chambers.

FIG. 5C corresponds to segment 5C of FIG. 4. Portion 416 of source pressure curve 410 shows a lowering of source pressure below operating pressure. Force of spring 122 and operating pressure in chamber 116 displace blocking member 118 to contact edge 126 and substantially block fluid flow between chambers 114 and 116, effectively maintaining operating pressure in chamber 116 as evidenced by portion 418 of curve 412. Note that as long as source pressure is above minimum pressure line 414 (i.e., portion 420 of curve 416), source pressure acting on piston 130 is sufficient to overcome force of spring 132 and piston 130 so that piston 130 and blocking member 118 are not engaged.

FIG. 5D corresponds to segment 5D of FIG. 4. Once source pressure drops below minimum pressure line 414 (i.e., at inflection point 422), force of spring 132 overcomes pressure force acting on piston 130 and piston 130 displaces blocking member 118. Source pressure experiences a small increase as pressure in the valve is equalized and then falls with the operating pressure.

Of course, changes and modifications to the above examples of the invention should be readily apparent to those having ordinary skill in the art, without departing from the spirit or scope of the invention as claimed. Although the invention is described by reference to specific preferred and/or example embodiments, it is clear that variations can be made without departing from the scope or spirit of the invention as claimed.

What I claim is:

1. A hydraulic valve, comprising:
a first fluid chamber hydraulically connected to a pressure source;
a second fluid chamber hydraulically connected to a pressure operator; and
a blocking member for controlling fluid flow between the first and second chambers, wherein the blocking member substantially blocks fluid flow between the first and second chambers when a pressure of fluid in the first chamber is greater than a minimum pressure and less than a pressure of fluid in the second chamber, and the blocking member is displaceable to enable fluid flow between the first and second chambers when the pressure of fluid in the first chamber is below the minimum pressure.

2. The hydraulic valve of claim 1, further comprising:
a first piston disposed in the second chamber; and
a first spring disposed in the second chamber, wherein the blocking member is connected to the first piston and is urgeable into a position substantially blocking fluid flow between the first and second chambers by the first spring.

3. The hydraulic valve of claim 2, wherein the blocking member is integral with the first piston.

4. The hydraulic valve of claim 2, wherein the first piston comprises a channel for equalizing pressure on the first piston.

5. The hydraulic valve of claim 4, wherein the first piston and the first spring are displaceable by fluid pressure in the first chamber acting on the blocking member.

6. The hydraulic valve of claim 2, further comprising:
a second piston disposed in the first chamber, and
a second spring disposed in the first chamber and for displacing the second piston, wherein the blocking member is urgeable into a position enabling fluid flow between the first and second chambers by the second piston.

7. The hydraulic valve of claim 6, wherein the second spring is displaceable by fluid pressure in the first chamber acting on the second piston.

8. The hydraulic valve of claim 6, further comprising an end cap including a drain, wherein the second spring is disposed between the second piston and the end cap.

9. A hydraulic valve, comprising:
a first hydraulic chamber;
a second hydraulic chamber;
a first piston and spring disposed in the first chamber, the first spring urging the first piston towards the second chamber;
a second piston and spring disposed in the second chamber, the second spring urging the second piston towards the first chamber; and
a blocking member displaceable by the first and second pistons for controlling fluid communication between the chambers.

10. The hydraulic valve of claim 9, further comprising an end cap including a drain, wherein the second spring is disposed between the second piston and the end cap.

11. A hydraulic valve, comprising:
a first orifice in fluid communication with a source of pressurized fluid;
a second orifice in fluid communication with an operator; and
a blocking member, wherein the blocking member is displaceable to substantially block fluid communication between the first and second orifices when a pressure of fluid at the first orifice is greater than a minimum pressure and less than a pressure of fluid at the second orifice, and the blocking member is displaceable to enable fluid communication between the first and second orifices when a pressure of fluid at the first orifice is below the minimum pressure.

12. The hydraulic valve of claim 11, further comprising first and second springs, wherein the blocking member is urgeable by the first spring into a position substantially blocking fluid communication between the first and second orifices and the blocking member is urgeable by the second spring into a position enabling fluid communication between the first and second orifices.

13. A pilot operator for a check valve comprising:
a piston disposed in a chamber; and
a spring, wherein the piston is displaceable by the spring to open the check valve when fluid pressure in the chamber is below a minimum value.

14. The pilot operator of claim 13, wherein the piston is displaceable by fluid pressure in the chamber to close the check valve when fluid pressure is above the minimum value.

15. The pilot operator of claim 14, further comprising an end cap, wherein the spring is disposed between the piston and the end cap.

16. The pilot operator of claim 15, wherein the end cap includes a drain.
